(19) United States
(12) Patent Application Publication
(10) Pub. No.: US 2015/0002419 A1
(43) Pub. Date: Jan. 1, 2015

(54) RECOGNIZING INTERACTIONS WITH HOT ZONES

(71) Applicant: Microsoft Corporation, Redmond, WA (US)

(72) Inventors: Chris White, Seattle, WA (US); Scott W. Haynie, Sammamish, WA (US); Jesse Kaplan, Sammamish, WA (US); John McQueen, Kirkland, WA (US)

(21) Appl. No.: 14/307,339

(22) Filed: Jun. 17, 2014

Related U.S. Application Data
(60) Provisional application No. 61/839,532, filed on Jun. 26, 2013.

(51) Int. Cl. G06F 3/0484; G06F 3/041; G06F 3/01

(52) U.S. Cl. CPC G06F 3/04847; G06F 3/017; G06F 3/0412
USPC 345/173

(57) ABSTRACT

A system and method for defining a three dimensional (3D) zone which, upon entrance or exit of an element as detected by a depth capture system, raises a digital event. The zone comprises a region of space in an environment the interaction with which occurs by activation of pixels in the zone. The event can be provided to an application to perform programmatic tasks based on the event. Generation of the event may be limited to the entrance or exit of a specific person, body part, or object, or a combination of these. Using the digital event, interaction with real world objects may be tied to digital events.

### CLAIM OF PRIORITY

This application claims the benefit of U.S. Provisional application Ser. No. 61/839,532 entitled RECOGNIZING INTERACTIONS WITH REAL WORLD OBJECTS, filed Jun. 26, 2013.

### BACKGROUND

In the past, computing applications such as computer games and multimedia applications have used controllers, remotes, keyboards, mice, or the like to allow users to manipulate game characters or other aspects of an application. More recently, computer games and multimedia applications have begun employing cameras and motion recognition to provide a natural user interface (“NUI”). With NUI, user gestures are detected, interpreted and used to control game characters or other aspects of an application.

Generally there is a strong line between the physical and the digital world. It is possible to build rich digital experiences, but there is generally not a tie back to the physical objects the experiences are about. There are a number of applications user interaction with real world objects would enhance the application experience.

### SUMMARY

Technology is described for defining a three dimensional (3D) zone which, upon activation of which by an element as detected by a depth capture system, will raise a digital event. Each zone consists of a region in three-dimensional space comprising a defined area, the interaction with which is detected by activation of a threshold number of pixels over a period of time detected by a capture device. The event can be provided to an application to perform programmatic tasks based on the event. The threshold may be defined in terms of an absolute number of pixels, or percentage of pixels in three dimensional capture data which must be activated in order to trigger the event. Generation of the event may be limited to the entrance or exit of a specific person, body part, or object. Using the digital event, interaction with real world objects may be tied to digital events. The zones can be adapted over time by learning if specific pixels are always “on” in order to filter them out of the persistent signal and automatic alignment of the capture device can be made to a previously recorded scene in order to automatically calibrate the camera and zones.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an example embodiment of a target recognition, analysis, and tracking system in which embodiments of the technology may operate.

FIG. 2 illustrates an embodiment of a system including hardware and software components for automatically generating a facial avatar of a user with a defined art style.

FIG. 3 illustrates an example embodiment of a computer system that may be used to embody and implement system and method embodiments of the technology.

FIG. 4A illustrates an exemplary depth image.

FIG. 4B depicts exemplary data in an exemplary depth image.

FIG. 5 shows a non-limiting visual representation of an example body model generated by skeletal recognition engine.

FIG. 6 shows a skeletal model as viewed from the front.

FIG. 7 shows a skeletal model as viewed from a skewed view.

FIGS. 8 and 9 illustrate an example embodiment of a user interacting with 3-D hot zones.

FIG. 10A is a flowchart illustrating a method in accordance with the present technology.

FIG. 10B is a flowchart illustrating a method tracking user interaction with a hot zone in accordance with the present technology.

FIG. 11 is a flowchart illustrating the use of a fired event to render a digital event.

FIG. 12 is a method illustrating the detection of interaction with a hot zone.

FIGS. 13 and 14 are flowchart illustrating methods for configuring hot zones. FIG. 15 is a flowchart illustrating a method for correcting issues with the hot zone or the camera.

FIG. 16 is an exemplary XML definition of a hot zone.

FIG. 17 illustrates the association of hot zones with specific capture devices.

### DETAILED DESCRIPTION

Technology is described for defining a three dimensional (3D) zone which, upon entrance or exit of an element as detected by a depth capture system, will raise a digital event. Activation of the region is determined by a change in the data of a threshold number of pixels in the region over a threshold period of time. Hence, the region may be activated by living beings and inanimate objects. The event can be provided to an application to perform programmatic tasks based on the event. The threshold for generating an event in the zone may be defined in terms of an absolute number of pixels, or percentage of pixels in three dimensional capture data which must be activated in order to trigger the event. Generation of the event may be limited to the entrance or exit of a specific person, body part, or object, or a combination of these. Using the digital event, interaction with real world objects may be tied to digital events. The zones can be adapted over time by learning if specific pixels are always “on” in order to filter them out of the persistent signal and automatic alignment of the capture device can be made to a previously recorded scene in order to automatically calibrate the camera and zones.

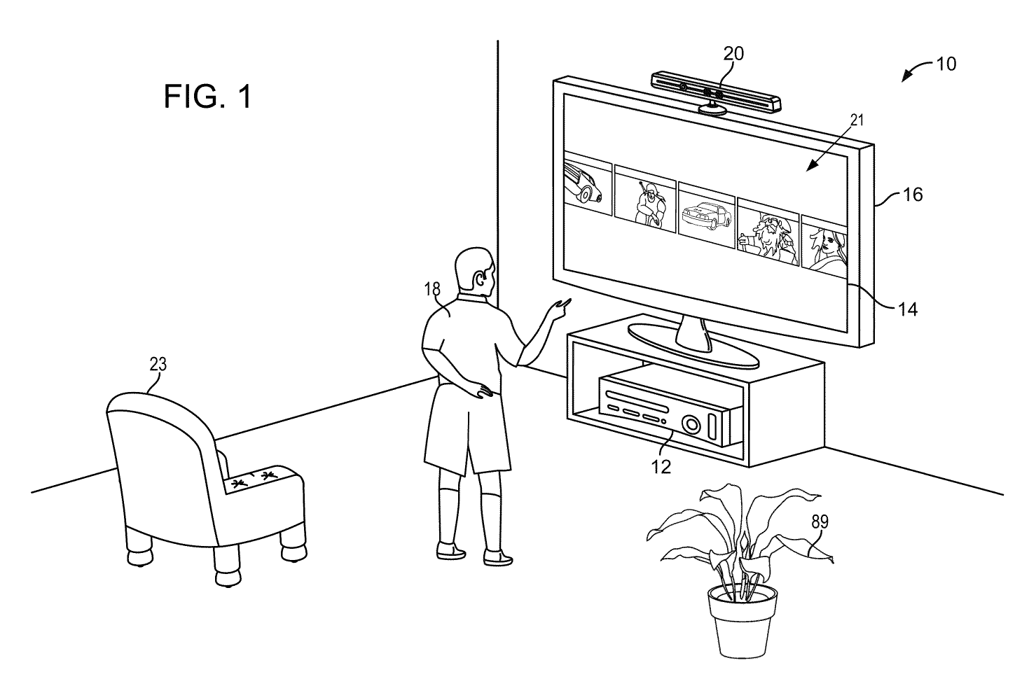

FIG. 1 illustrates an example embodiment of a target recognition, analysis, and tracking system in which embodiments of the technology may operate. In this contextual example, a user 18 is in his living room, as indicated by the illustrative static, background objects 23 of a chair and a plant. The user 18 interacts with a natural user interface (NUI) which recognized gestures as control actions. The NUI is implemented with a 3D image capture device 20 in which field of view user 18 is standing, and a computer system 12 to select a multimedia application from a menu being displayed under control of software executing on the computer system 12 on display 14 of a display monitor 16, a high definition television also in the living room in this example. The computer system 12 in this example is a gaming console, for example one from the XBOX® family of consoles. The 3D image capture device 20 may include a depth sensor providing depth data which may be correlated with the image data captured as well. An example of such an image capture device is a depth sensitive camera of the Kinect® family of cameras. The capture device 20, which may also capture audio data via a microphone, and computer system 12 together may implement a target recognition, analysis, and tracking system 10 which may be used to recognize, analyze, and/or track a human target such as the user 18 including the user's head features including facial features.

Other system embodiments may use other types of computer systems such as desktop computers, and mobile devices like laptops, smartphones and tablets including or communicatively coupled with depth sensitive cameras for capturing the user's head features and a display for showing a resulting personalized avatar. In any event, whatever type or types of computer systems are used for generating the facial personalized avatar, one or more processors generating the facial avatar will most likely include at least one graphics processing unit (GPU).

Suitable examples of a system 10 and components thereof are found in the following co-pending patent applications: U.S. patent application Ser. No. 12/475,094, entitled “Environment And/Or Target Segmentation,” filed May 29, 2009; U.S. patent application Ser. No. 12/511,850, entitled “Auto Generating a Visual Representation,” filed Jul. 29, 2009; U.S. patent application Ser. No. 12/474,655, entitled “Gesture Tool,” filed May 29, 2009; U.S. patent application Ser. No. 12/603,437, entitled “Pose Tracking Pipeline,” filed Oct. 21, 2009; U.S. patent application Ser. No. 12/475,308, entitled “Device for Identifying and Tracking Multiple Humans Over Time,” filed May 29, 2009, U.S. patent application Ser. No. 12/575,388, entitled “Human Tracking System,” filed Oct. 7, 2009; U.S. patent application Ser. No. 12/422,661, entitled “Gesture Recognizer System Architecture,” filed Apr. 13, 2009; U.S. patent application Ser. No. 12/391,150, entitled “Standard Gestures,” filed Feb. 23, 2009; and U.S. patent application Ser. No. 12/474,655, entitled “Gesture Tool,” filed May 29, 2009.

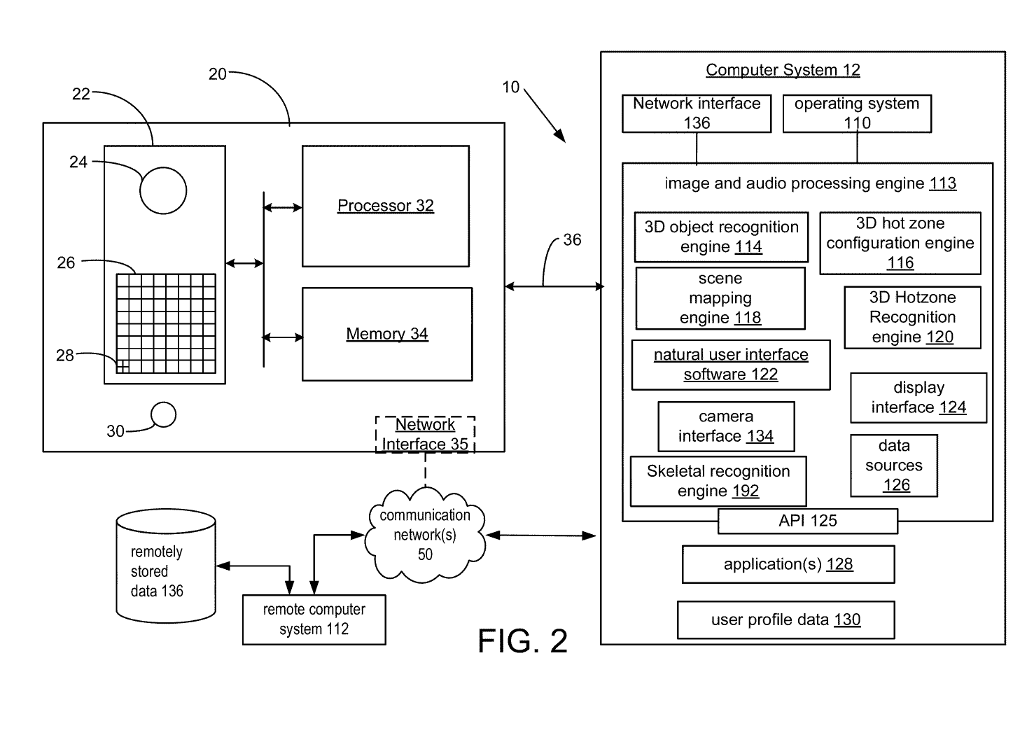

FIG. 2 illustrates an embodiment of a system including hardware and software components for detecting user movements relative to three dimensional hot zones and triggering digital events. An example embodiment of the capture device 20 is configured to capture video having a depth image that may include depth values via any suitable technique including, for example, time-of-flight, structured light, stereoscopic cameras or the like. According to one embodiment, the capture device 20 may organize the calculated depth information into “Z layers,” or layers that may be perpendicular to a Z axis extending from the depth camera along its line of sight. X and Y axes may be defined as being perpendicular to the Z axis, or may be defined in projective space, expanding out from the camera origin based on the camera intrinsics. The Y axis may be vertical and the X axis may be horizontal. Together, the X, Y and Z axes define the 3D real world space captured by capture device 20.

In the context of this disclosure, reference is made to a three dimensional Cartesian coordinate system. However, it should be understood that any of a number of various types of coordinate systems may be used in accordance with the present technology.

As shown in FIG. 2, this exemplary capture device 20 may include an image and depth camera component 22 which captures a depth image by a pixelated sensor array 26. A depth value may be associated with each captured pixel. Some examples of a depth value are a length or distance in, for example, centimeters, millimeters, or the like of an object in the captured scene from the camera. Sensor array pixel 28 is a representative example of a pixel with subpixel sensors sensitive to RGB visible light plus an IR sensor for determining a depth value for pixel 28. Other arrangements of depth sensitive and visible light sensors may be used. An infrared (IR) illumination component 24 may emit an infrared light onto the scene, and the IR sensors detect the backscattered light from the surface of one or more targets and objects in the scene in the field of view of the sensor array 26 from which a depth map of the scene can be created. In some examples, time-of-flight analysis based on intensity or phase of IR light received at the sensors may be used for making depth determinations.

According to another embodiment, the capture device 20 may include two or more physically separated cameras that may view a scene from different angles, to obtain visual stereo data that may be resolved to generate depth information.

The capture device 20 may further include a microphone 30 to receive audio signals provided by the user to control applications that may be executing on the computing environment 12 as part of the natural user interface.

In the example embodiment, the capture device 20 may include a processor 32 in communication with the image and depth camera component 22 and having access to a memory component 34 that may store instructions for execution by the processor 32 as well as images or frames of images captured and perhaps processed by the 3D camera. The memory component 34 may include random access memory (RAM), read only memory (ROM), cache, Flash memory, a hard disk, or any other suitable storage component. The processor 32 may also perform image processing, including some object recognition steps, and formatting of the captured image data.

As shown in the example of FIG. 2, the capture device 20 is communicatively coupled with the computing environment 12 via a communication link 36 which may be wired or a wireless connection. Additionally, the capture device 20 may also include a network interface 35 and optionally be communicatively coupled over one or communication networks 50 to a remote computer system 112 for sending the 3D image data to the remote computer system 112. In some embodiments, the computer system 12, or the remote computer system 12 may provide a clock to the capture device 20 that may be used to determine when to capture, for example, a scene.

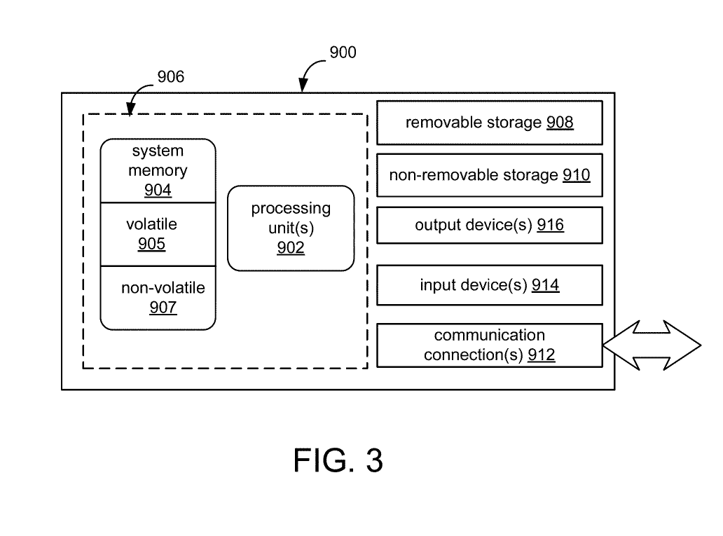

In the illustrated example, computer system 12 includes a variety of software applications, data sources and interfaces. In other examples, the software may be executing across a plurality of computer systems, one or more of which may be remote. Additionally, the applications, data and interfaces may also be executed and stored remotely by a remote computer system 112 with which either the capture device 20 or the computer system 12 communicates. Additionally, data for use by the applications, such as rules and definitions discussed in more detail with respect to FIGS. 3A and 3B, may be stored and accessible via remotely stored data 136.

Computer system 12 comprises an operating system 110, a network interface 136 for communicating with other computer systems, a display interface 124 for communicating data, instructions or both, to a display like display 14 of display device 16, and a camera interface 134 for coordinating exchange of depth image data and instructions with 3D capture device 20. An image and audio processing engine 113 comprises natural user interface software 122 which may include software like gesture recognition and sound recognition software for identifying actions of a user's body or vocal cues which are commands or advance the action of a multimedia application. Additionally, 3D object recognition engine 114 detects boundaries using techniques such as edge detection and compares the boundaries with stored shape data for identifying types of objects. Color image data may also be used in object recognition. A type of object which can be identified is a human body including body parts like a human head. A scene mapping engine 118 tracks a location of one or more objects in the field of view of the 3D capture device. Additionally, object locations and movements may be tracked over time with respect to a camera independent coordinate system.

The 3D hot zone configuration engine 116 generates a 3D hot zone definition for use by the system of FIG. 2. Embodiments of ways of generating the hot zone are discussed in the FIGS. below. The 3D hot zone detection engine 120 automatically detects interactions with defined hot zones, determines whether to fire a digital event through, for example API 125, and makes adjustments to the hot zones when changes to the hot zones occur. Data sources 126 may be data stored locally for use by the applications of the image and audio processing engine 113.

An application programming interface (API) 125 provides an interface for multimedia applications 128. Besides user specific data like personal identifying information including personally identifying image data, user profile data 130 may also store data or data references to stored locations of a user profile information, user-identifying characteristics such as user-identified skeletal models.

A skeletal recognition engine 192 is included to create skeletal models from observed depth data through capture device 20. Exemplary skeletal models are described below.

It should be recognized that all or a portion of computer system 12 may be implemented by a computing environment coupled to the capture device via the networks 50, with no direct connection 36 between the system and the capture device. Any image and audio processing engine 113, application 128 and user profile date 130 may be stored and implemented in a cluster computing environment.

FIG. 3 illustrates an example embodiment of a computer system that may be used to embody and implement system and method embodiments of the technology. For example, FIG. 3 is a block diagram of an embodiment of a computer system like computer system 12 or remote computer system 112 as well as other types of computer systems such as mobile devices. The scale, quantity and complexity of the different exemplary components discussed below will vary with the complexity of the computer system. FIG. 3 illustrates an exemplary computer system 900. In its most basic configuration, computing system 900 typically includes one or more processing units 902 including one or more central processing units (CPU) and one or more graphics processing units (GPU). Computer system 900 also includes memory 904. Depending on the exact configuration and type of computer system, memory 904 may include volatile memory 905 (such as RAM), non-volatile memory 907 (such as ROM, flash memory, etc.) or some combination of the two. This most basic configuration is illustrated in FIG. 3 by dashed line 906. Additionally, computer system 900 may also have additional features/functionality. For example, computer system 900 may also include additional storage (removable and/or non-removable) including, but not limited to, magnetic or optical disks or tape. Such additional storage is illustrated in FIG. 3 by removable storage 908 and non-removable storage 910.

Computer system 900 may also contain communication module(s) 912 including one or more network interfaces and transceivers that allow the device to communicate with other computer systems. Computer system 900 may also have input device(s) 914 such as keyboard, mouse, pen, voice input device, touch input device, etc. Output device(s) 916 such as a display, speakers, printer, etc. may also be included.

The example computer systems illustrated in the FIGS. include examples of computer readable storage devices. A computer readable storage device is also a processor readable storage device. Such devices may include volatile and nonvolatile, removable and non-removable memory devices implemented in any method or technology for storage of information such as computer readable instructions, data structures, program modules or other data. Some examples of processor or computer readable storage devices are RAM, ROM, EEPROM, cache, flash memory or other memory technology, CD-ROM, digital versatile disks (DVD) or other optical disk storage, memory sticks or cards, magnetic cassettes, magnetic tape, a media drive, a hard disk, magnetic disk storage or other magnetic storage devices, or any other device which can be used to store the information and which can be accessed by a computer.

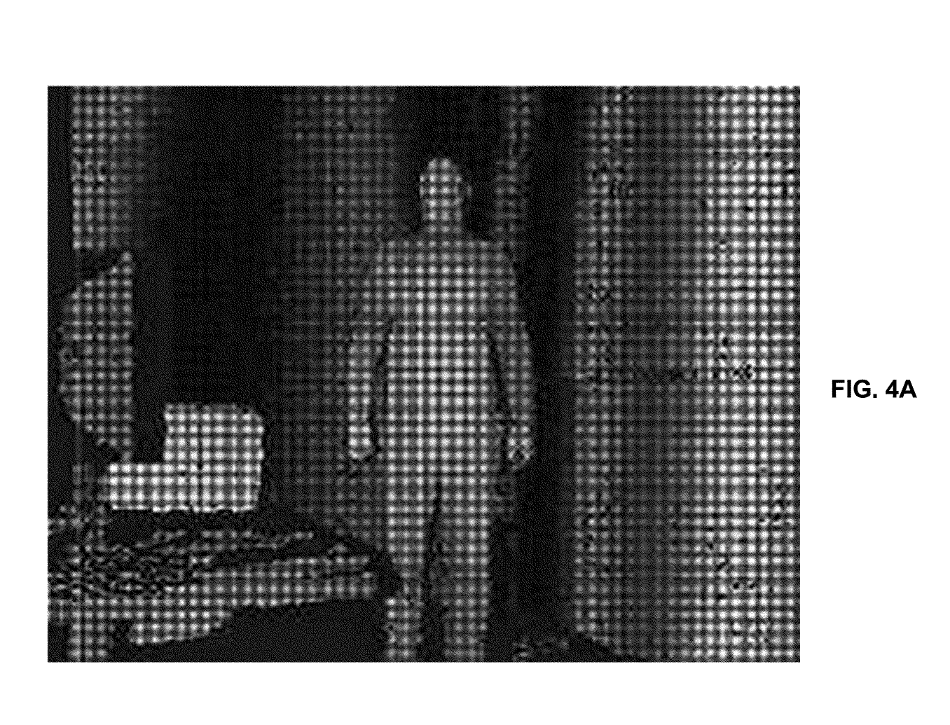

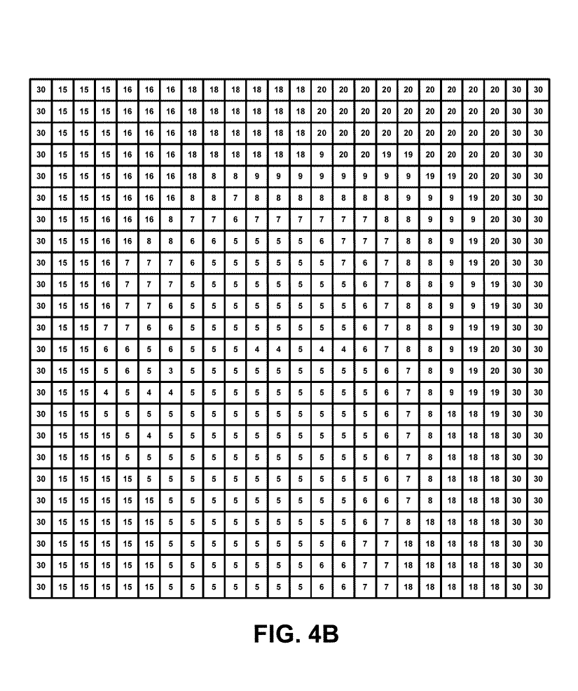

FIG. 4A illustrates an example embodiment of a depth image that may be received at computing system 112 from capture device 120. According to an example embodiment, the depth image may be an image and/or frame of a scene captured by, for example, the 3D camera 226 and/or the RGB camera 228 of the capture device 120 described above with respect to FIG. 2. As shown in FIG. 4A, the depth image may include a human target corresponding to, for example, a user such as the user 118 described above with respect to FIG. 1 and one or more non-human targets (i.e. real world objects) such as a wall, a table, a monitor, or the like in the captured scene. As described above, the depth image may include a plurality of observed pixels where each observed pixel has an observed depth value associated therewith. For example, the depth image may include a two-dimensional (2-D) pixel area of the captured scene where each pixel at particular x-value and y-value in the 2-D pixel area may have a depth value such as a length or distance in, for example, centimeters, millimeters, or the like of a target or object in the captured scene from the capture device. In other words, a depth image can specify, for each of the pixels in the depth image, a pixel location and a pixel depth. Following a segmentation process, e.g., performed by the by the runtime engine 244, each pixel in the depth image can also have a segmentation value associated with it. The pixel location can be indicated by an x-position value (i.e., a horizontal value) and a y-position value (i.e., a vertical value). The pixel depth can be indicated by a z-position value (also referred to as a depth value), which is indicative of a distance between the capture device (e.g., 120) used to obtain the depth image and the portion of the user represented by the pixel. The segmentation value is used to indicate whether a pixel corresponds to a specific user, or does not correspond to a user.

In one embodiment, the depth image may be colorized or grayscale such that different colors or shades of the pixels of the depth image correspond to and/or visually depict different distances of the targets from the capture device 120. Upon receiving the image, one or more high-variance and/or noisy depth values may be removed and/or smoothed from the depth image; portions of missing and/or removed depth information may be filled in and/or reconstructed; and/or any other suitable processing may be performed on the received depth image.

FIG. 4B provides another view/representation of a depth image (not corresponding to the same example as FIG. 4A). The view of FIG. 4B shows the depth data for each pixel as an integer that represents the distance of the target to capture device 120 for that pixel. The example depth image of FIG. 4B shows 24×24 pixels; however, it is likely that a depth image of greater resolution would be used.

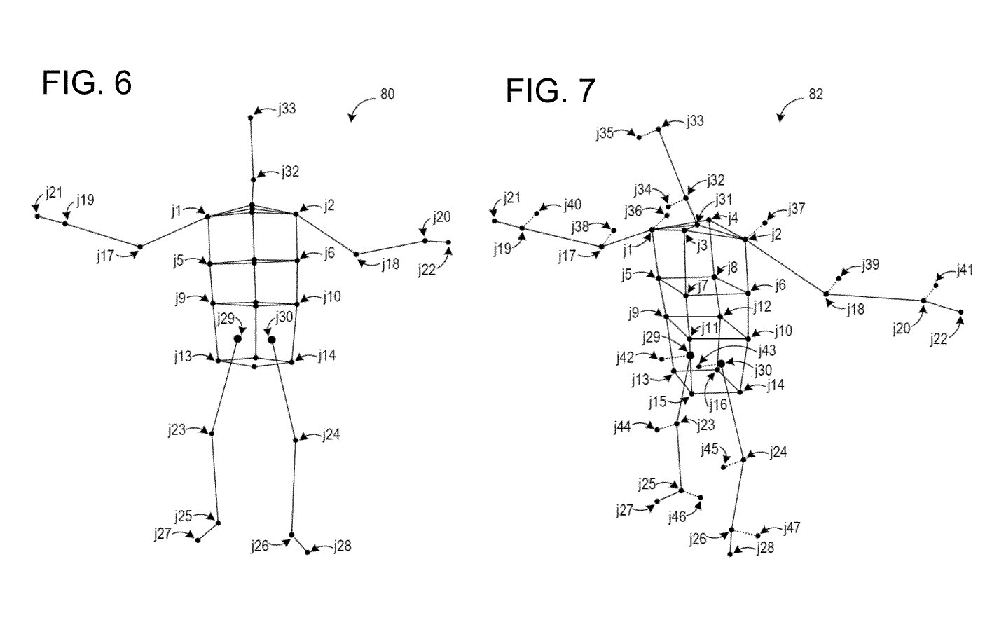

FIG. 6 shows a non-limiting visual representation of an example body model 70 generated by skeletal recognition engine 192. Body model 70 is a machine representation of a modeled target (e.g., user 18 from FIG. 1). The body model 70 may include one or more data structures that include a set of variables that collectively define the modeled target in the language of a game or other application/operating system.

A model of a target can be variously configured without departing from the scope of this disclosure. In some examples, a body model may include one or more data structures that represent a target as a three-dimensional model including rigid and/or deformable shapes, or body parts. Each body part may be characterized as a mathematical primitive, examples of which include, but are not limited to, spheres, anisotropically-scaled spheres, cylinders, anisotropic cylinders, smooth cylinders, boxes, beveled boxes, prisms, and the like. In one embodiment, the body parts are symmetric about an axis of the body part.

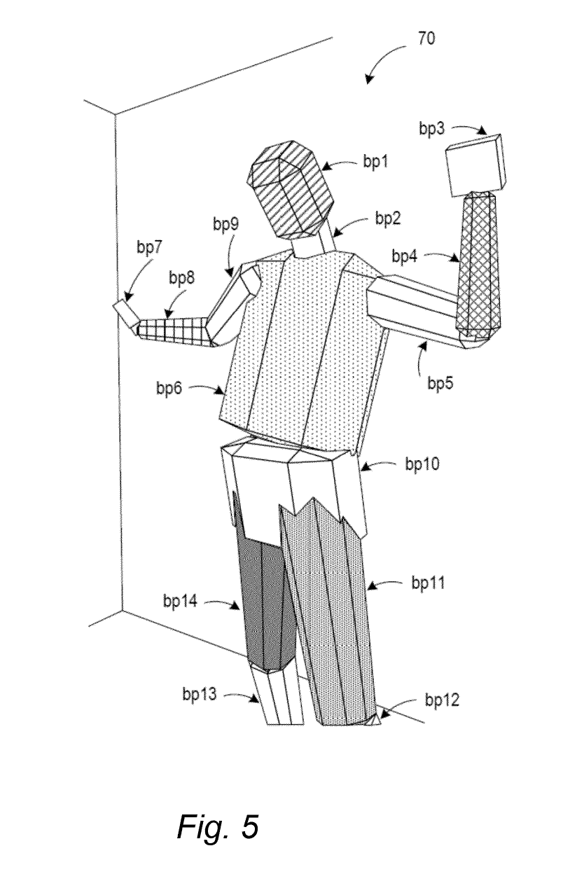

For example, body model 70 of FIG. 5 includes body parts bp1 through bp14, each of which represents a different portion of the modeled target. Each body part is a three-dimensional shape. For example, bp3 is a rectangular prism that represents the left hand of a modeled target, and bp5 is an octagonal prism that represents the left upper-arm of the modeled target. Body model 70 is exemplary in that a body model 70 may contain any number of body parts, each of which may be any machine-understandable representation of the corresponding part of the modeled target. In one embodiment, the body parts are cylinders.

A body model 70 including two or more body parts may also include one or more joints. Each joint may allow one or more body parts to move relative to one or more other body parts. For example, a model representing a human target may include a plurality of rigid and/or deformable body parts, wherein some body parts may represent a corresponding anatomical body part of the human target. Further, each body part of the model may include one or more structural members (i.e., “bones” or skeletal parts), with joints located at the intersection of adjacent bones. It is to be understood that some bones may correspond to anatomical bones in a human target and/or some bones may not have corresponding anatomical bones in the human target.

The bones and joints may collectively make up a skeletal model, which may be a constituent element of the body model. In some embodiments, a skeletal model may be used instead of another type of model, such as model 70 of FIG. 5. The skeletal model may include one or more skeletal members for each body part and a joint between adjacent skeletal members. Example skeletal model 80 and example skeletal model 82 are shown in FIGS. 6 and 7, respectively. FIG. 6 shows a skeletal model 80 as viewed from the front, with joints j1 through j33. FIG. 7 shows a skeletal model 82 as viewed from a skewed view, also with joints j1 through j33. A skeletal model may include more or fewer joints without departing from the spirit of this disclosure. Further embodiments of the present system explained hereinafter operate using a skeletal model having 31 joints.

In one embodiment, the system 100 adds geometric shapes, which represent body parts, to a skeletal model, to form a body model. Note that not all of the joints need to be represented in the body model. For example, for an arm, there could be a cylinder added between joints j2 and j18 for the upper arm, and another cylinder added between joints j18 and j20 for the lower arm. In one embodiment, a central axis of the cylinder links the two joints. However, there might not be any shape added between joints j20 and j22. In other words, the hand might not be represented in the body model.

In one embodiment, geometric shapes are added to a skeletal model for the following body parts: Head, Upper Torso, Lower Torso, Upper Left Arm, Lower Left Arm, Upper Right Arm, Lower Right Arm, Upper Left Leg, Lower Left Leg, Upper Right Leg, Lower Right Leg. In one embodiment, these are each cylinders, although another shape may be used. In one embodiment, the shapes are symmetric about an axis of the shape.

A shape for body part could be associated with more than two joints. For example, the shape for the Upper Torso body part could be associated with j1, j2, j5, j6, etc.

The above described body part models and skeletal models are non-limiting examples of types of models that may be used as machine representations of a modeled target. Other models are also within the scope of this disclosure. For example, some models may include polygonal meshes, patches, non-uniform rational B-splines, subdivision surfaces, or other high-order surfaces. A model may also include surface textures and/or other information to more accurately represent clothing, hair, and/or other aspects of a modeled target. A model may optionally include information pertaining to a current pose, one or more past poses, and/or model physics. It is to be understood that a variety of different models that can be posed are compatible with the herein described target recognition, analysis, and tracking system.

Software pipelines for generating skeletal models of one or more users within a field of view (FOV) of capture device 120 are known. One such system is disclosed for example in United States Patent Publication 2012/0056800, entitled “System For Fast, Probabilistic Skeletal Tracking,” filed Sep. 7, 2010, which application is incorporated by reference herein in its entirety.

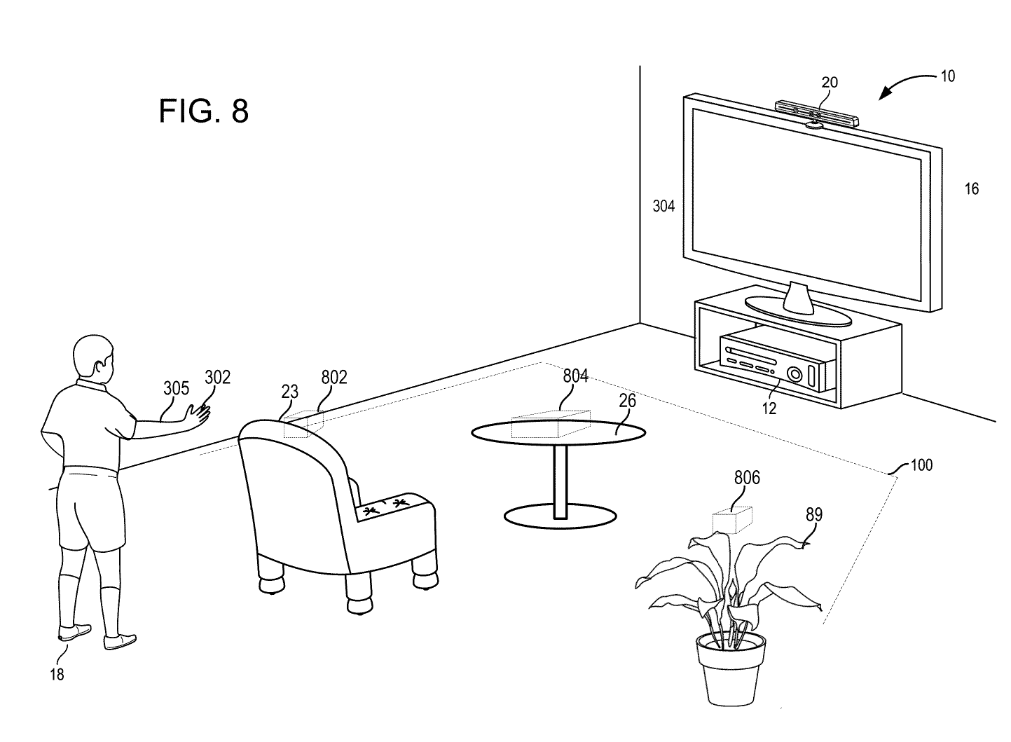

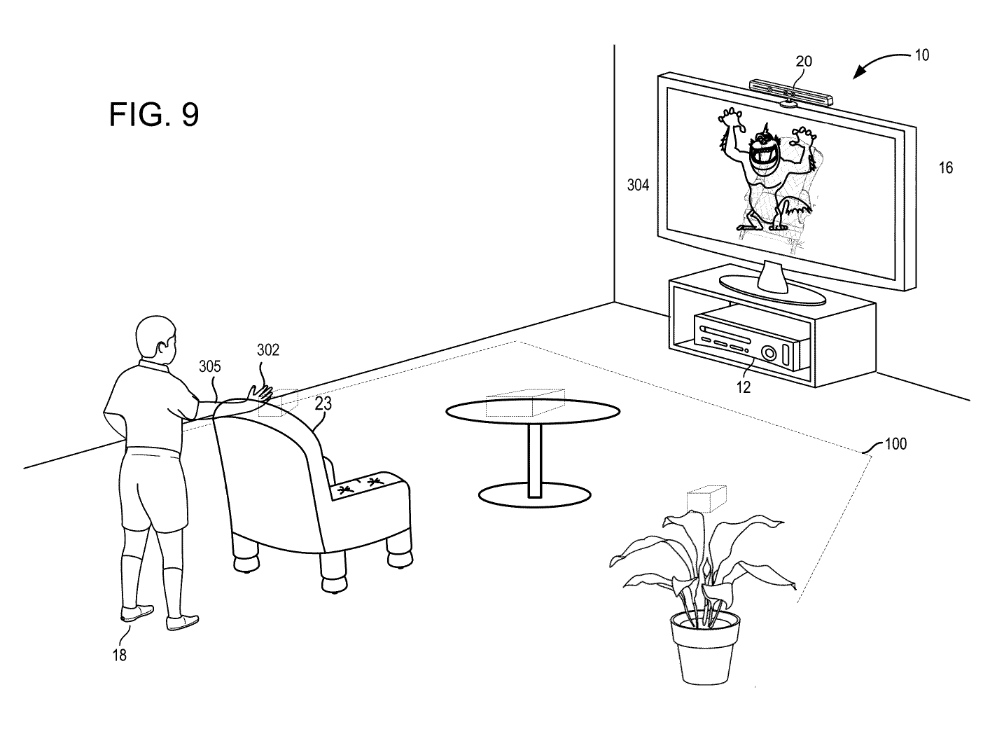

FIGS. 8 and 9 illustrate a user 18 interacting with 3D hot zones in accordance with the present technology. In FIG. 8, three 3D hot zones are illustrated at 802, 804 and 806. It should be understood that the 3D hot zones 802, 804, and 806 are not visible to the user, but represent three-dimensional volumes to capture device 20 with which a user may interact and generate a digital event. Each hot zone may be defined by a bounding region defined as a three dimensional area of pixels, each pixel defined in coordinate space. As noted above, the coordinate space may be defined by Cartesian coordinates relative to the camera, relative to another fiduciary point in the environment, or another type of coordinate system. For example, a conical coordinate system may be used relative to the position of the camera. The region may be any volumetric shape, including, for example, a square or rectangular box, a sphere, a cone, a cylinder, a pyramid or any multisided volume. The fiduciary point may be a known object in the room, a room corner, or any physical reference point.

As illustrated in FIG. 8, the 3D hot zones 802, 804 and 806 are associated with real world objects such as chair 23, table 26, and plant 89. Each of the 3D hot zones 802, 804 and 806 represents three-dimensional volumes within the viewing field 100 of capture device 120. In this context, a digital event can be any event that can be used by an application to generate its own event or by instructions for causing a processor to react programmatically. In one example, when a user touches a chair, a game application may render an event in the game relative to a virtual chair rendered by the game. As illustrated in FIG. 9, when a user 18 arm 305 and hand 302 engage a 3D hot zone 802, a digital event is fired and a resulting digital action may occur, such as the display of the monster on display 16 being moved to sit on a virtual representation of chair 23. Numerous other examples of uses of an event created when a user interacts with a 3D hot zone may be realized. Although three hot zones are shown, it should be understood any number of hot zones may be defined in an environment.

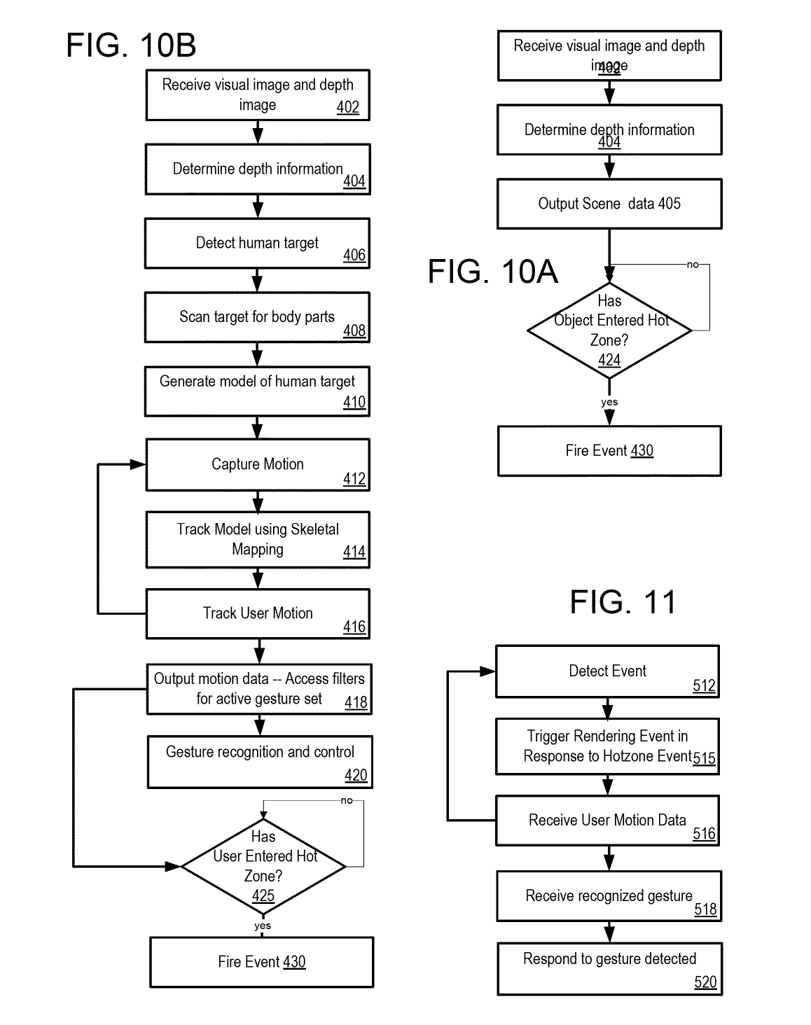

FIG. 10A illustrates a method detected interaction with a hot zone in accordance with the present technology. At step 402, processor 32 of the capture device 20 receives a visual image and a depth image from the image capture component 22. In other examples, only a depth image is received at step 402. The data comprises depth and visual data (or only depth data) within a field of view of the capture device. The depth image and visual image can be captured by any of the sensors in image capture component 22 or other suitable sensors as are known in the art. In one embodiment the depth image is captured separately from the visual image. In some implementations the depth image and visual image are captured at the same time while in others they are captured sequentially or at different times. In other embodiments the depth image is captured with the visual image or combined with the visual image as one image file so that each pixel has an R value, a G value, a B value and a Z value (representing distance).

At step 404 depth information corresponding to the visual image and depth image are determined. The visual image and depth image received at step 402 can be analyzed to determine depth values for one or more targets within the image. Capture device 20 may capture or observe a capture area that may include one or more targets. At 405, the scene data of the field of view of the capture device is output and analyzed by, for example, a processing device 32 or computer system 12. At 424 a determination is made as to whether an object (a living being or an inanimate object) has entered the hot zone. As described herein this determination is made by a finding of a change in the data associated with the hot zone over a threshold period of time. In one embodiment, the change in data is a change in depth data. In alternative embodiments, a change in visual data may activate the hot zone. At step 430, a digital event is fired. The method of FIG. 10A may loop continuously to scan an environment for interactions with hot zones.

FIG. 10B is a flowchart describing one embodiment of a process for detecting user movements relative to three dimensional hot zones and triggering digital events. At step 402, processor 32 of the capture device 20 receives a visual image and depth image from the image capture component 22.

At step 404 depth information corresponding to the visual image and depth image are determined. At step 406, the capture device determines whether the depth image includes a human target. In one example, each target in the depth image may be flood filled and compared to a pattern to determine whether the depth image includes a human target. In one example, the edges of each target in the captured scene of the depth image may be determined. The depth image may include a two dimensional pixel area of the captured scene for which each pixel in the 2D pixel area may represent a depth value such as a length or distance for example as can be measured from the camera. The edges may be determined by comparing various depth values associated with for example adjacent or nearby pixels of the depth image. If the various depth values being compared are greater than a pre-determined edge tolerance, the pixels may define an edge. The capture device may organize the calculated depth information including the depth image into Z layers or layers that may be perpendicular to a Z-axis extending from the camera along its line of sight to the viewer. The likely Z values of the Z layers may be flood filled based on the determined edges. For instance, the pixels associated with the determined edges and the pixels of the area within the determined edges may be associated with each other to define a target or a physical object in the capture area.

At step 408, the capture device scans the human target for one or more body parts. The human target can be scanned to provide measurements such as length, width or the like that are associated with one or more body parts of a user, such that an accurate model of the user may be generated based on these measurements. In one example, the human target is isolated and a bit mask is created to scan for the one or more body parts. The bit mask may be created for example by flood filling the human target such that the human target is separated from other targets or objects in the capture area elements. At step 410 a model of the human target is generated based on the scan performed at step 408. The bit mask may be analyzed for the one or more body parts to generate a model such as a skeletal model, a mesh human model or the like of the human target. For example, measurement values determined by the scanned bit mask may be used to define one or more joints in the skeletal model. The bitmask may include values of the human target along an X, Y and Z-axis. The one or more joints may be used to define one or more bones that may correspond to a body part of the human.

According to one embodiment, to determine the location of the neck, shoulders, or the like of the human target, a width of the bitmask, for example, at a position being scanned, may be compared to a threshold value of a typical width associated with, for example, a neck, shoulders, or the like. In an alternative embodiment, the distance from a previous position scanned and associated with a body part in a bitmask may be used to determine the location of the neck, shoulders or the like.

In one embodiment, to determine the location of the shoulders, the width of the bitmask at the shoulder position may be compared to a threshold shoulder value. For example, a distance between the two outer most Y values at the X value of the bitmask at the shoulder position may be compared to the threshold shoulder value of a typical distance between, for example, shoulders of a human. Thus, according to an example embodiment, the threshold shoulder value may be a typical width or range of widths associated with shoulders of a body model of a human.

In another embodiment, to determine the location of the shoulders, the bitmask may be parsed downward a certain distance from the head. For example, the top of the bitmask that may be associated with the top of the head may have an X value associated therewith. A stored value associated with the typical distance from the top of the head to the top of the shoulders of a human body may then added to the X value of the top of the head to determine the X value of the shoulders. Thus, in one embodiment, a stored value may be added to the X value associated with the top of the head to determine the X value associated with the shoulders.

In one embodiment, some body parts such as legs, feet, or the like may be calculated based on, for example, the location of other body parts. For example, as described above, the information such as the bits, pixels, or the like associated with the human target may be scanned to determine the locations of various body parts of the human target. Based on such locations, subsequent body parts such as legs, feet, or the like may then be calculated for the human target.

According to one embodiment, upon determining the values of, for example, a body part, a data structure may be created that may include measurement values such as length, width, or the like of the body part associated with the scan of the bitmask of the human target. In one embodiment, the data structure may include scan results averaged from a plurality depth images. For example, the capture device may capture a capture area in frames, each including a depth image. The depth image of each frame may be analyzed to determine whether a human target may be included as described above. If the depth image of a frame includes a human target, a bitmask of the human target of the depth image associated with the frame may be scanned for one or more body parts. The determined value of a body part for each frame may then be averaged such that the data structure may include average measurement values such as length, width, or the like of the body part associated with the scans of each frame. In one embodiment, the measurement values of the determined body parts may be adjusted such as scaled up, scaled down, or the like such that measurement values in the data structure more closely correspond to a typical model of a human body. Measurement values determined by the scanned bitmask may be used to define one or more joints in a skeletal model at step 410.

At step 412, motion is captured from the depth images and visual images received from the capture device. In one embodiment capturing motion at step 414 includes generating a motion capture file based on the skeletal mapping as will be described in more detail hereinafter. At 414, the model created in step 410 is tracked using skeletal mapping and to track user motion at 416. For example, the skeletal model of the user 18 may be adjusted and updated as the user moves in physical space in front of the camera within the field of view. Information from the capture device may be used to adjust the model so that the skeletal model accurately represents the user. In one example this is accomplished by one or more forces applied to one or more force receiving aspects of the skeletal model to adjust the skeletal model into a pose that more closely corresponds to the pose of the human target and physical space.

At step 416 user motion is tracked and as indicated by the loop to step 412, steps 412-414 and 416 are continually repeated to allow for subsequent steps to track motion data and output control information in a continuous manner.

At step 418 motion data is provided to an application, including any application operable on the computing systems described herein. Such motion data may further be evaluated to determine whether a user is performing a pre-defined gesture at 420. Step 420 can be performed based on the UI context or other contexts. For example, a first set of gestures may be active when operating in a menu context while a different set of gestures may be active while operating in a game play context. At step 420 gesture recognition and control is performed. The tracking model and captured motion are passed through the filters for the active gesture set to determine whether any active gesture filters are satisfied. Any detected gestures are applied within the computing environment to control the user interface provided by computing environment 12. Step 420 can further include determining whether any gestures are present and if so, modifying the user-interface action that is performed in response to gesture detection.

At step 425, contemporaneously with steps 418 and 420, a determination is made as to whether a user or other object has interacted with a 3D hot zone. A determination of interactions with a hot zone is discussed below. If a determination is made that a user has interacted with a hot zone at step 425, then at step 430, a digital event is fired. The method at step 425 repeats, constantly monitoring for interactions with defined hot zones.

FIG. 11 represents a process which may occur on a processing device such as computing system 12 in response to receiving a fired event 430. At step 512, an event may be detected by a processing device. The event may be detected by an application running on the processing device, or any code instructing the processor to respond to and seek events via API 125. At 515, a digital event, such as a game or rendering event may be triggered in response to the hot zone event. The rendering event may occur an application such as a game or communication application. For example, the monster is rendered on the chair in FIG. 9. At step 516, additional user motion data is received for use by the application or code in generating actions within the game or code. At step 518, gestures recognized by the capture device may be received. At step 520, the application responds to gestures recognized by the capture device and user motions.

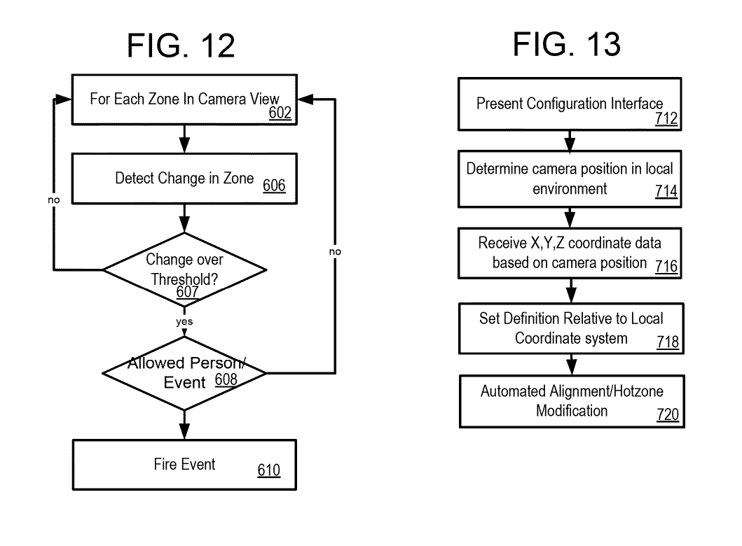

FIG. 12 illustrates a method for detecting a change in a hot zone, which in one embodiment may comprise a method for performing step 425 in FIG. 10. At 602, for each zone within a capture device's view, the change in the zone is detected at 606. The change in the zone can be a change in the depth data associated with a few pixels, or some percentage of pixels, or a major change in the depth data from a majority of pixels within a bounding region of the zone. At step 607, a determination is made as to whether not the change is above a threshold level required to define an interaction with the zone. At 607, the change can be defined as a percentage of pixels within the 3D hot zone, or an absolute number of pixels within the 3D hot zone. As described below, the definition of the hot zone may be changed or filtered based on movements of real objects which may impinge the zone, occupying some percentage of defined pixels within the zone volume. Optionally, at step 608, determination is made as to whether or not the change in the threshold has been made by an allowed person, object, or appendage of a person.

As a human target has been detected at step 406 above, models of the human target generated at step 410 can be associated with individual users, and users identified and tracked. In some embodiments, events are only fired when an identified individual interacts with a particular hot zone. This interaction can occur and be defined on a hot zone by hot zone basis. That is, individual users may be associated with individual zones, or a plurality of zones. Hot zones may further include permissions defining which types of interactions with the zones may occur. For example, certain zones may require a human body part interaction of others may allow for only a static object interaction. It should be understood that step 608 is optional.

If the change in the zone has been determined to be over the threshold at 607 and the person or object allowed to change the threshold at 608, then a digital event is fired at 610.

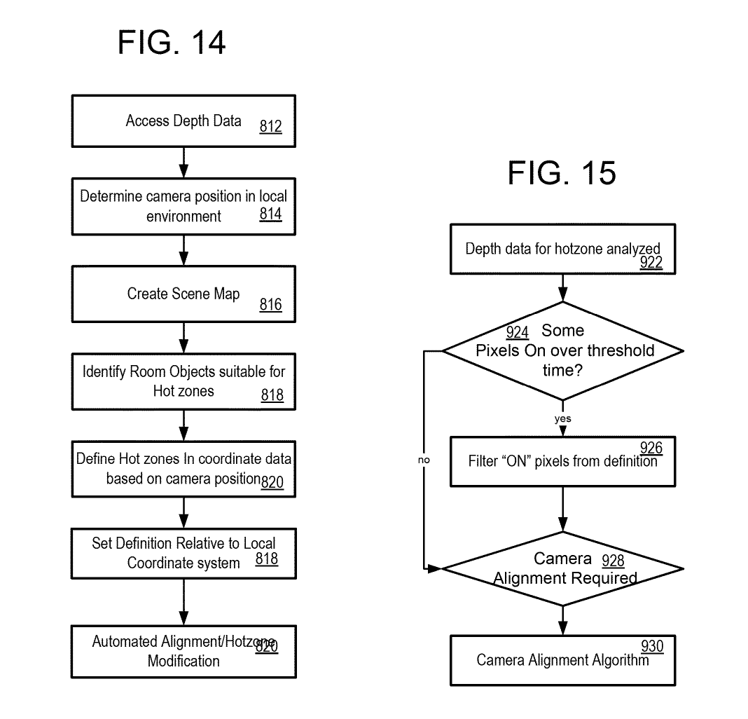

FIGS. 13 and 14 illustrate two different methods for defining a 3D hot zone. In FIG. 13, 3D hot zones may be defined in space by a user. At 712, a configuration interface is presented. The configuration interface may be presented on a computing device having a user interface. At step 714, the camera position in the local environment is determined. In one aspect, local coordinate system is based on the camera position, and 3D hot zones defined relative to a local coordinate system. At step 716, X, Y and Z coordinate is received from the configuration interface for each 3D hot zone to be defined. At step 718, one or more 3D hot zones are stored relative to the local coordinate system.

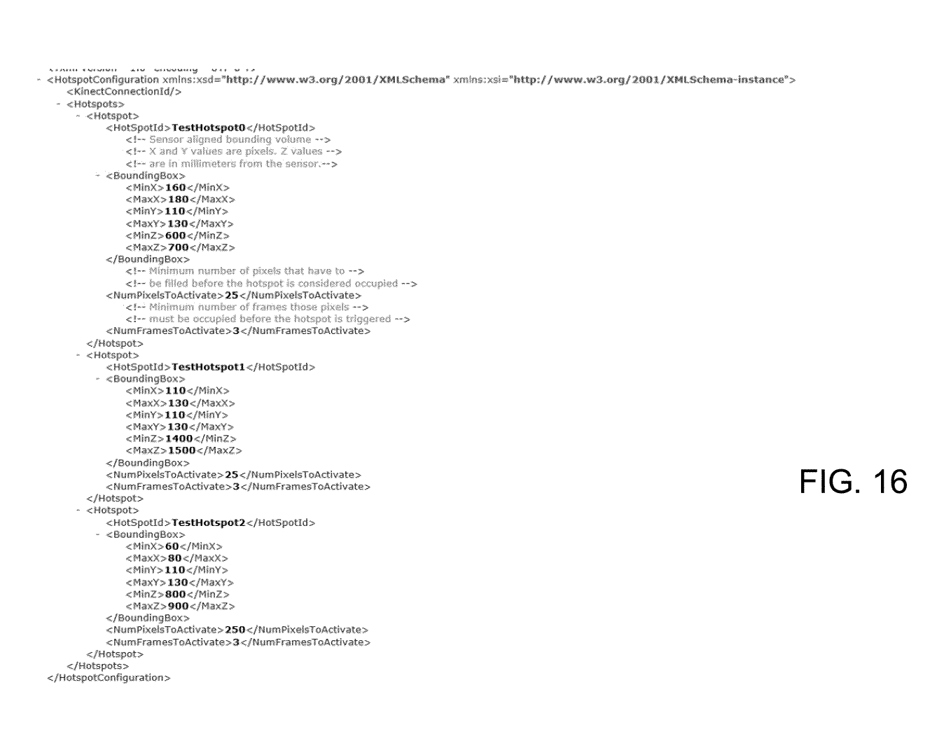

In this context, the local coordinate system may be defined as dependent or independent of the camera position. If independent of the coordinate system, the local coordinate system can be associated with the local environment and a fiduciary point within the environment. Hot zones can be associated with a scene map of the environment and if the position of the camera moves within the environment, coordinates determined from the fiduciary point. Alternatively, local coordinate system may be defined by the camera position. An example of hot zone definitions fixed to the camera position are illustrated in FIG. 16. In still another alternative, each hot zone may be associated with a particular real object such that if the object is repositioned, a recalibration of the capture device would determine the repositioning of the object and change the definition of the hot zone to match the new positioned relative to the object.

At step 720, an automated alignment/hot zone modification process may be performed. If, for example, a solid object begins impinging a hot zone which was previously defined in un-encumbered space, or the capture device is moved relative to the original position, the alignment/modification process can compensate for these changes.

FIG. 14 is a method illustrating a hot zone definition process performed in an automated manner. At step 812, depth data is accessed by the processing device. At 814, the camera position is determined in local space. Step 814 is equivalent to the same step in FIG. 13. A step 816, a scene map is created. The scene map may include a depth image of the local where the capture device is located. Using the scene map created at step 816, one or more real world objects suitable for interaction by a user can be identified, and locations for hot zones relative to the objects determined at 818. The creation of hot zones for real-world objects at 818 may be dependent upon the application which will be utilizing the hot zones in this context. Alternatively, hot zones may be created for all of a number of identifiable objects within an environment. At step 820, an automated hot zone alignment/modification process can be used at 820. Steps 818 and 820 are equivalent to steps 718 and 720 discussed above.

FIG. 15 illustrates the automated alignment hot zone modification process. At step 922, depth data for a particular hot zone is analyzed. The analysis will include a comparison relative to the volume occupied by the hot zone, and a record of which pixels in the hot zone should have particular depth values. And 924, a determination is made as to whether or not some pixels are “on” by having depth data different than that contained in the hot zone definition. The determination of whether a pixel is “on” is relative to a change in the depth data for that pixel over at least a threshold amount of time or frames. If the pixels within a bounding region definition of a hot zone remain active or “on” over a threshold amount of time, this may indicate a change in the physical environment which needs to be addressed. If pixels are determined to be on for a threshold amount time in step 924, then at step 926, the “on” pixels will be filtered from the definition. Filtering the “on” pixels from the definition at 926 does not change the definition, but does not take the “on” pixels into account in determining whether or not the hot zone has been interacted with. Alternatively, or in addition to filtering the pixels, the X, Y, Z bounding definition of the hot zone can be altered. As noted below with respect to FIG. 16, the bounding of the hot zone can be created by ranges of pixels in the X-Y plane and a range of depth in the Z direction. Alternating the hot-zone definition may comprise altering the pixel range(s) in the X-Y plane and/or the Z distance from the capture device (or other reference/fiduciary point for the coordinate system. Either filtering or changing the bounding definition comprises modifying the hot zone. At step 928, a determination is made as to whether not camera alignment is required. A number of checks can be utilized to determine whether or not camera has moved relative to its original position. If so, a camera alignment algorithm can be performed at 930. A number of different camera alignment algorithms can be utilized including, for example, using Iterative Closest Point (ICP), or another similar but more robust tracking algorithm.

In a further embodiment, a system such as Kinect Fusion provides a single dense surface model of an environment by integrating the depth data from a capture device over time from multiple viewpoints. The camera pose is tracked as the sensor is moved (its location and orientation). These multiple viewpoints of the objects or environment can be fused (averaged) together into a single reconstruction voxel volume. This volume can be used to define environments and hot zones within these mapped environments.

In one embodiment, hot zones are defined in XML format for use interpretation by a computing device. An example of a hotspot definition is shown in FIG. 16. The XML definition illustrated in FIG. 16 shows three exemplary hot zones defined. Hot zones in this context are defined by X and Y coordinates defining a number of pixels, and the Z data defining a distance from the camera. The X and Y coordinates define a start and end pixel distance for each of the X and Y axes within the field of view of the capture device. Also shown are the absolute number of pixels within the hot zone required to activate the hot zone, and the length of time, defined by a number of frames, that the absolute number of pixels must be engaged.

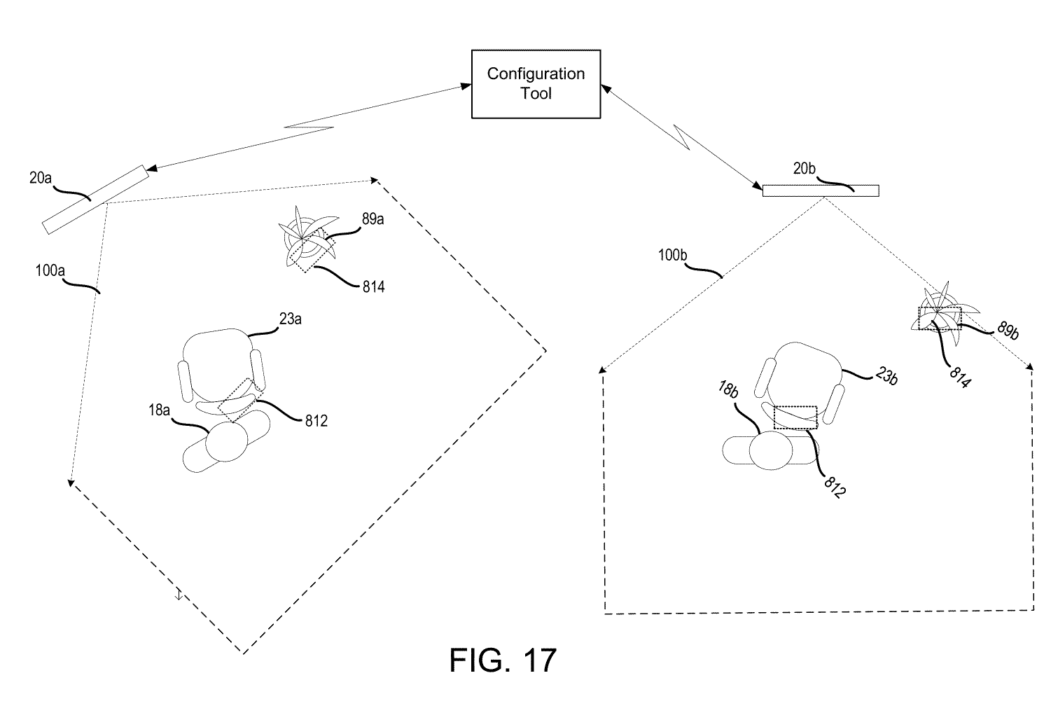

FIG. 17 illustrates a first and second capture devices 20a and 20b, each having a respective field of view 100a and 100b. As illustrated therein, a series of hot zones 812, 814 and 822, 824, can be associated with each field of view. Each capture device 20a, and 20b can be connected to a central configuration tool, provided on a processing device, to allow association a specific hotspots with specific capture devices. Used in this manner, two or more devices can be dedicated to hot zone tracking while a third device may be dedicated to tracking user interactions.

Embodiments of the technology include a computer implemented method of rendering a digital event. The method includes defining one or more three-dimensional hot zones in a real world environment, each hot zone comprising a volume of space;

monitoring the real world environment to receive depth data, the depth data including the one or more three-dimensional hot zones in the real world environment; detecting an interaction between a second real-world object and at least one of the one or more hot zones by analysis of the depth data, the interaction occurring when a threshold number of active pixels in the hot zone have a change in depth distance based on the presence of the second real-world object; and responsive to the detecting, outputting a signal responsive to the interaction between the second real-world object and the one or more hot zones to at least one application on a processing device.

Embodiments include a computer implemented method of any of the previous embodiments wherein the depth data may be referenced by a three dimensional coordinate system referencing the real world environment, the three dimensional coordinates defined relative to a position of a depth capture device, each hot zone defined by coordinates in the coordinate system.

Embodiments include a computer implemented method of any of the previous embodiments wherein the depth data may be referenced by a three dimensional coordinate system referencing the real world environment, the three dimensional coordinates defined relative to a position of a fiduciary object in a field of view of the capture device, each hot zone defined by coordinates in the coordinate system.

Embodiments include a computer implemented method of any of the previous embodiments further including determining that a change in continually active pixels within the bounding region has occurred, and modifying the hot zone.

Embodiments include a computer implemented method of any of the previous embodiments wherein said modifying comprises filtering continually active pixels from the hot zone.

Embodiments include a computer implemented method of any of the previous embodiments wherein said modifying comprises changing one or more of the dimensional coordinates defining the hot zone to thereby move the hot zone.

Embodiments include a computer implemented method of any of the previous embodiments wherein the detecting includes the interaction occurring when a threshold number of active pixels in the hot zone have a change in depth distance for at least a threshold period of time.

Embodiments include a computer implemented method of any of the previous embodiments wherein the three dimensional coordinates are referenced relative to a depth data capture device, and further including determining whether a camera re-alignment resulting from a change in active pixels in the hot zone is needed and if so, aligning the camera using a camera alignment algorithm.

In another embodiment an apparatus generating an indication of an interaction with a real would object, the interaction being output to an application to create a digital event, is provided. The apparatus includes a capture device having a field of view of a scene, the capture device outputting depth data of the field of view relative to a coordinate system. The apparatus further includes a processing device, coupled to the capture device, receiving the depth data and responsive to code instructing the processing device to: receive a definition of one or more hot zones in the scene, each hot zone comprising a volume of physical space associated with a first real world object defined by a plurality of pixels in a coordinate system having a reference point; detect an interaction between a second real-world object and one or more hot zones by detecting an interaction comprising an activation of a threshold number of pixels by changing the depth within the plurality of pixels in the one or more hot zones for a threshold period of time; and output a signal responsive to the interaction between the second real-world object and the one or more hot zones, the signal output to an application configured to use the signal to generate an event in the application.

Embodiments include an apparatus of any of the previous embodiments wherein the coordinate system is an X, Y and Depth coordinate system, with X and Y coordinates comprising a minimum and maximum pixel count relative to an X and Y axis measured from a capture device, and a Z coordinate defined as a distance from the capture device, the definition including a minimum number of active pixels for activation.

Embodiments include an apparatus of any of the previous embodiments including instructing the processing device to further including determine whether a camera re-alignment resulting from a change in active pixels in the hot zone is needed and if so, aligning the camera using a camera alignment algorithm.

Embodiments include an apparatus of any of the previous embodiments wherein receiving a definition comprises receiving an data file having specified therein for each hot zone X and Y coordinates comprising a minimum and maximum pixel count relative to an X and Y axis measured from a reference point, and a Z coordinate defined as a distance from the reference point, the definition including a minimum number of active pixels for activation.

Embodiments include an apparatus of any of the previous embodiments further including code instructing the processor to determine that a change in continually active pixels within the bounding region has occurred, and modifying the hot zone.

Embodiments include an apparatus of any of the previous embodiments wherein the apparatus is configured to modify said hot zone by filtering continually active pixels from the hot zone.

Embodiments include an apparatus of any of the previous embodiments wherein the apparatus is configured to modify said hot zone by changing one or more of the coordinates defining the hot zone to move the zone.

In another embodiment, a computer storage medium including code instructing a processor with access to the storage medium to perform a processor implemented method is provided. The method includes receiving one or more hot zone definitions within a real world scene, each hot zone comprising a volume of physical space associated with a first real world object defined by a three-dimensional set of pixels determined relative to a reference point in the environment, which may be referenced by the processor; determining an interaction within the scene, the interaction comprising determining a change in depth data within a volume of said one or more hot zones within the scene for a threshold period of time; responsive to determining an interaction, outputting a signal indicating that an interaction has occurred to an application configured to use the interaction to generate a digital event; determining an adjustment to a definition of the hot zone; and automatically modifying the hot-zone when determining an adjustment specifies an adjustment is needed.

Embodiments include a computer storage medium of any of the previous embodiments wherein the reference point comprises a fiduciary point in a field of view of the capture device and the method further includes adjusting the coordinate space subsequent to a movement of the capture device relative to the position to a new position.

Embodiments include a computer storage medium of any of the previous embodiments wherein the reference point is the capture device method further includes a determining that a capture device providing said depth data has changed position relative to the hot zone and aligning the capture device.

Embodiments include a computer storage medium of any of the previous embodiments wherein the method further includes determining that a change in continually active pixels within the hot zone has occurred, and filtering continually active pixels within hot zone from the hot zone definition.

Embodiments include a computer storage medium of any of the previous embodiments wherein the method further includes determining that a change in continually active pixels within the hot zone has occurred, and changing at least one of coordinates defining a position of the zone.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

What is claimed is:

1. A computer implemented method of rendering a digital event, comprising:
defining one or more three-dimensional hot zones in a real world environment, each hot zone comprising a volume of space;
monitoring the real world environment to receive depth data, the depth data including the one or more three-dimensional hot zones in the real world environment.
detecting an interaction between a second real-world object and at least one of the one or more hot zones by analysis of the depth data, the interaction occurring when a threshold number of active pixels in the hot zone have a change in depth distance based on the presence of the second real-world object; and
responsive to the detecting, outputting a signal responsive to the interaction between the second real-world object and the one or more hot zones to at least one application on a processing device.

2. The computer implemented method of claim 1 wherein the depth data may be referenced by a three dimensional coordinate system referencing the real world environment, the three dimensional coordinates defined relative to a position of a depth capture device, each hot zone defined by coordinates in the coordinate system.

3. The computer implemented method of claim 1 wherein the depth data may be referenced by a three dimensional coordinate system referencing the real world environment, the three dimensional coordinates defined relative to a position of a fiduciary object in a field of view of the capture device, each hot zone defined by coordinates in the coordinate system.

4. The computer implemented method of claim 3 further including determining that a change in continually active pixels within the bounding region has occurred, and modifying the hot zone.

5. The computer implemented method of claim 4 wherein said modifying comprises filtering continually active pixels from the hot zone.

6. The computer implemented method of claim 4 wherein said modifying comprises changing one or more of the dimensional coordinates defining the hot zone to thereby move the hot zone.

7. The computer implemented method of claim 1 wherein the detecting includes the interaction occurring when a threshold number of active pixels in the hot zone have a change in depth distance for at least a threshold period of time.

8. The computer implemented method of claim 1 wherein the three dimensional coordinates are referenced relative to a depth data capture device, and further including determining whether a camera re-alignment resulting from a change in active pixels in the hot zone is needed and if so, aligning the camera using a camera alignment algorithm.

9. An apparatus generating an indication of an interaction with a real would object, the interaction being output to an application to create a digital event, the apparatus comprising:
a capture device having a field of view of a scene, the capture device outputting depth data of the field of view relative to a coordinate system; and
a processing device, coupled to the capture device, receiving the depth data and responsive to code instructing the processing device to:
receive a definition of one or more hot zones in the scene, each hot zone comprising a volume of physical space associated with a first real world object defined by a plurality of pixels in a coordinate system having a reference point;
detect an interaction between a second real-world object and one or more hot zones by detecting an interaction comprising an activation of a threshold number of pixels by changing the depth within the plurality of pixels in the one or more hot zones for a threshold period of time; and
output a signal responsive to the interaction between the second real-world object and the one or more hot zones, the signal output to an application configured to use the signal to generate an event in the application.

10. The apparatus of claim 9 wherein the coordinate system is an X, Y and Depth coordinate system, with X and Y coordinates comprising a minimum and maximum pixel count relative to an X and Y axis measured from a capture device, and a Z coordinate defined as a distance from the capture device, the definition including a minimum number of active pixels for activation.

11. The apparatus of claim 9 including instructing the processing device to further including determine whether a camera re-alignment resulting from a change in active pixels in the hot zone is needed and if so, aligning the camera using a camera alignment algorithm.

12. The apparatus of claim 10 wherein receiving a definition comprises receiving an data file having specified therein for each hot zone X and Y coordinates comprising a minimum and maximum pixel count relative to an X and Y axis measured from a reference point, and a Z coordinate defined as a distance from the reference point, the definition including a minimum number of active pixels for activation.

13. The apparatus of claim 9 further including code instructing the processor to determine that a change in continually active pixels within the bounding region has occurred, and modifying the hot zone.

14. The apparatus of claim 13 wherein the apparatus is configured to modify said hot zone by filtering continually active pixels from the hot zone.

15. The apparatus of claim 13 wherein the apparatus is configured to modify said hot zone by changing one or more of the coordinates defining the hot zone to move the zone.

16. A computer storage medium, the computer storage medium including code instructing a processor with access to the storage medium to perform a processor implemented method, comprising:
receiving one or more hot zone definitions within a real world scene, each hot zone comprising a volume of physical space associated with a first real world object defined by a three-dimensional set of pixels determined relative to a reference point in the environment, which may be referenced by the processor;
determining an interaction within the scene, the interaction comprising determining a change in depth data within a volume of said one or more hot zones within the scene for a threshold period of time;
responsive to determining an interaction, outputting a signal indicating that an interaction has occurred to an application configured to use the interaction to generate a digital event;
determining an adjustment to a definition of the hot zone; and
automatically modifying the hot-zone when determining an adjustment specifies an adjustment is needed.

17. The computer storage medium of claim 16 wherein the reference point comprises a fiduciary point in a field of view of the capture device and the method further includes adjusting the coordinate space subsequent to a movement of the capture device relative to the position to a new position.

18. The computer storage medium of claim 16 wherein the reference point is the capture device method further includes a determining that a capture device providing said depth data has changed position relative to the hot zone and aligning the capture device.

19. The computer storage medium of claim 16 wherein the method further includes determining that a change in continually active pixels within the hot zone has occurred, and filtering continually active pixels within hot zone from the hot zone definition.

20. The computer storage medium of claim 16 wherein the method further includes determining that a change in continually active pixels within the hot zone has occurred, and changing at least one of coordinates defining a position of the zone.
